(19) United States
(12) Patent Application Publication
(10) Pub. No.: US 2024/0166380 A1
(43) Pub. Date: May 23, 2024

(54) Drones-Based Outdoor Shield System and Method of Use

(71) Applicant: Manuel Ordieres, Aubrey, TX (US)

(72) Inventor: Manuel Ordieres, Aubrey, TX (US)

(21) Appl. No.: 18/504,542

(22) Filed: Nov. 8, 2023

Related U.S. Application Data
(60) Provisional application No. 63/426,187, filed on Nov. 17, 2022.

(51) Int. Cl. B64U 10/13

(52) U.S. Cl. CPC B64U 10/13; B64U 2101/00

(57) ABSTRACT

A drone-supported shade system for providing adaptable outdoor shelter from adverse weather conditions is disclosed. The system comprising at least three programmable drones which can be controlled automatically or manually through various means, including mobile applications or control boxes. A tarp is connected to a hook of each drone to function as a shield from the weather elements. Each drone incorporates a GPS module and an array of sensors for accurate positioning and collision avoidance. Propellers powered by brushless motors offer mechanical support and stability during flight, while a rechargeable battery system provides electrical power. In some embodiments, a transceiver module enables communication between operators and drones, enabling activation and deactivation of the drones. A programmable microcontroller facilitates diverse flight patterns and coordination among drones to maintain a protective tarp in a generally planar position, thus offering effective protection from sun or inclement weather.

### CROSS-REFERENCE TO RELATED APPLICATION

The present application claims priority to, and the benefit of, U.S. Provisional Application No. 63/426,187, which was filed on Nov. 17, 2022, and is incorporated herein by reference in its entirety.

### FIELD OF THE INVENTION

The present invention generally relates to the field of drone systems. More specifically, the present invention relates to a novel drone shade system. The system includes at least three drones connected to the corners of a triangular, rectangular, or rectilinear shaped tarp. The drones are programmable to fly or hover at the same altitudes and spaced apart distances to keep tension on the tarp without the need for a frame. Additionally, the drones may hover or follow the intended beneficiary of the tarp. Each drone has a metal hook or ring to firmly secure each corner of the tarp. Users can maintain optimal coverage while outdoors working or playing regardless of weather. Accordingly, the present disclosure makes specific reference thereto. Nonetheless, it is to be appreciated that aspects of the present invention are also equally applicable to other like applications, devices, and methods of manufacture.

### BACKGROUND

By way of background, individuals are required to be outdoors to do specific job responsibilities and to do personal work as well. Regardless of the weather conditions, such as rain, snow, extreme heat, or cold, individuals cannot avoid being outdoors. When individuals are outdoors, they are naturally exposed to the weather, which includes rain, sunlight, wind, and other atmospheric conditions. Without any form of protection or shelter, weather can have adverse effects on the well-being of individuals especially who are on two-wheelers, pedestrians, individuals temporarily living on roads, and more.

As an example, Ultraviolet (UV) rays of sunlight can be harmful to the skin and eyes of individuals when exposed to the UV rays for extended periods without protection. Prolonged exposure to UV rays can lead to skin damage, sunburn, and an increased risk of skin cancer. Also, rainfall can be both inconvenient, uncomfortable and can lead to discomfort, cold, and potential health issues. Taking shelter during rain consumes time, as individuals pause their activities and wait until the rain stops or find suitable shelter. The need to pause and take shelter from rain can disrupt work or outdoor activities. Rain can also ruin a project that is waiting to dry or cure (i.e., concrete in the process of drying).

Many individuals carry umbrellas as a portable and personal form of rain and UV protection. Storing a wet umbrella can be messy and inconvenient. Further, an umbrella is required to be held by a user. Also, an umbrella provides inadequate protection and provides protection for a small surface area. In some settings where individuals gather in a large surface area, improved protection from weather elements is desired. Individuals desire an improved form of shelter or protection in the form of an overhead tarp when spending time outdoors to avoid the negative effects of weather conditions.

Therefore, there exists a long-felt need in the art for an overhead protective device for protecting one or more individuals from weather elements. Additionally, there is a long-felt need in the art for an overhead tarp that is automatically placed over a target area for protection from weather elements. Moreover, there is a long-felt need in the art for a drone system that includes a plurality of drones to place a tarp over an intended beneficiary or project. Further, there is a long-felt need in the art for a drone-based weather elements protection system that supports a tarp over one or more users to protect the users from sun, rain, and other elements. Furthermore, there is a long-felt need in the art for a protective tarp that hovers over an intended beneficiary using a plurality of drones. Finally, there is a long-felt need in the art for a drone-based tarp system that obviates the need for individuals to go indoors or take shelter during any type of inclement weather and obviates using any conventional protective device, such as an umbrella.

The subject matter disclosed and claimed herein, in one embodiment thereof, comprises a portable and adaptable outdoor shield protection system. The system is used for providing shade and shelter outdoors. The system further comprises at least three drones, the drones are positioned in a co-planar alignment when deployed to provide protection from weather elements. A protective tarp, generally triangular, rectilinear, or rectangular, is attached to the metal hooks of the drones. A metal hook is positioned on each of the at least three drones, the tarp serves as a protective shield against weather elements when the drones are in the deployed position. The drones are automatically transitioned from the deployed position to an unused position wherein in the unused position, the drones are not in co-planar alignment. A tension is maintained in the tarp for providing protection from weather elements and the system can be used for a worksite, stadium, and individual users.

In this manner, the outdoor shield protection system of the present invention accomplishes all of the foregoing objectives and provides users with at least three drones designed to support a large tarp overhead a person or outdoor area (intended beneficiary) to protect the area from weather elements. Each drone supports one corner of the triangular, rectangular, or rectilinear shaped tarp, keeping the tarp elevated over the intended beneficiary. The system can be automatically activated or manually activated using a control device. The system obviates the need of other protective devices outdoors during inclement weather.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a portable and adaptable outdoor sunshade or shield protection system. The system is used for providing shade and shelter outdoors to users and projects, effectively protecting the users from sun exposure or adverse weather conditions encountered in outdoor environments. The system further comprises at least three drones, the drones are positioned in a co-planar alignment when deployed to provide protection from weather elements. A protective tarp, generally triangular, rectilinear, or rectangular, is attached to the metal hooks. A metal hook is positioned on each of the at least three drones, the tarp serves as a protective shield against weather elements when the drones are in the deployed position. The drones are automatically transitioned from the deployed position to an unused position wherein in the unused position, the drones are not in co-planar alignment.

In yet another embodiment, a drone-supported sunshade or shield system is disclosed. The system comprises at least three drones with an attached common tarp wherein the drones are attached to corners of the tarp, a control device for activating the system, a wireless communication channel for facilitating communication between the control device and the drones, wherein an instruction signal is transmitted from the control device to the drones, whereby a microcontroller of each drone receives the instruction signal to activate the drone and attain a preconfigured flight height, the drones are in co-planar alignment when the drones are at the preconfigured flight height maintaining a tension in the tarp to cover the area underneath the tarp for protection from weather elements.

In a further embodiment, the system is automatically activated where the drones autonomously attain a preconfigured flight height upon detecting adverse weather elements, such as rain, using one or more drones.

In still a further embodiment, one drone from the at least three drones is designated as the master drone, wherein the master drone receives the instruction signal from the control device and activates the entire system.

In a further embodiment, a drone for use in a drone-based outdoor shield system is disclosed. The drone includes a GPS module for determining and conveying the drone's positioning, including relative positioning with respect to other drones of the shade system to prevent collisions, a combination of motors and propellers to supply the mechanical power for the drone's flight, altitude maintenance, and flight duration, a rechargeable and replaceable battery system, a transceiver module for facilitating the receipt and transmission of instructions from an operator or control unit, a programmable microcontroller to enable the programming of diverse flight patterns and coordination among multiple drones, wherein the drones of the shade system are attached to corners of a tarp allowing the tarp to function as a protective shield for surface below the tarp to protect from weather elements.

In still another embodiment of the present invention, a drone supported sunshade or shield system is disclosed. The system includes at least three drones connected to the corners of a triangular, rectangular, or rectilinear shaped tarp. The drones are configured to fly or hover at the same altitude in a coplanar alignment and a spaced apart distance to keep tension on the tarp without the need for a frame. Each drone has a metal hook or ring to firmly secure each corner of the tarp. The drones can be manually or automatically activated to fly or hover in coplanar alignment and drones are configured to follow location of an intended beneficiary of the system.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of the portable and adaptable outdoor sunshade or shield protection system of the present invention in an installed position in accordance with the disclosed structure;

FIG. 2 illustrates a block diagram showing the functional components of a drone system used in the portable and adaptable outdoor sunshade or shield protection system of the present invention in accordance with the disclosed structure;

FIG. 3 illustrates a block diagram illustrating activation of the protective drone system of the present invention for installation in accordance with the disclosed architecture; and

FIG. 4 illustrates a flow chart depicting the process of the drones-supported sunshade or shield system of the present invention following the intended beneficiary of the tarp in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for an overhead protective device for protecting one or more individuals or work projects from weather elements. Additionally, there is a long-felt need in the art for an overhead tarp that is automatically placed over a target area for protection from weather elements. Moreover, there is a long-felt need in the art for a drone system that includes a plurality of drones to place a tarp over an intended beneficiary of the tarp. Further, there is a long-felt need in the art for a drone-based weather elements protection system that supports a tarp over one or more users to protect the users from sun, rain, and other elements. Furthermore, there is a long-felt need in the art for a protective tarp that hovers over an intended beneficiary, or work project, using a plurality of drones. Finally, there is a long-felt need in the art for a drone-based tarp system that obviates the need for individuals to go indoors or take a shelter during any type of inclement weather and obviates using any conventional protective device, such as an umbrella.

The present invention, in one exemplary embodiment, is a drone for use in a drone-based outdoor shield system. The drone includes a GPS module for determining and conveying the drone's positioning, including relative positioning with respect to other drones of the shade system to prevent collisions, a combination of motors and propellers to supply the mechanical power for the drone's flight, altitude maintenance, and flight duration, a rechargeable and replaceable battery system, a transceiver module for facilitating the receipt and transmission of instructions from an operator or control unit, a programmable microcontroller to enable the programming of diverse flight patterns and coordination among multiple drones, wherein the drones of the shade system are attached to corners of a tarp allowing the tarp to function as a protective shield for surface below the tarp to protect from weather elements.

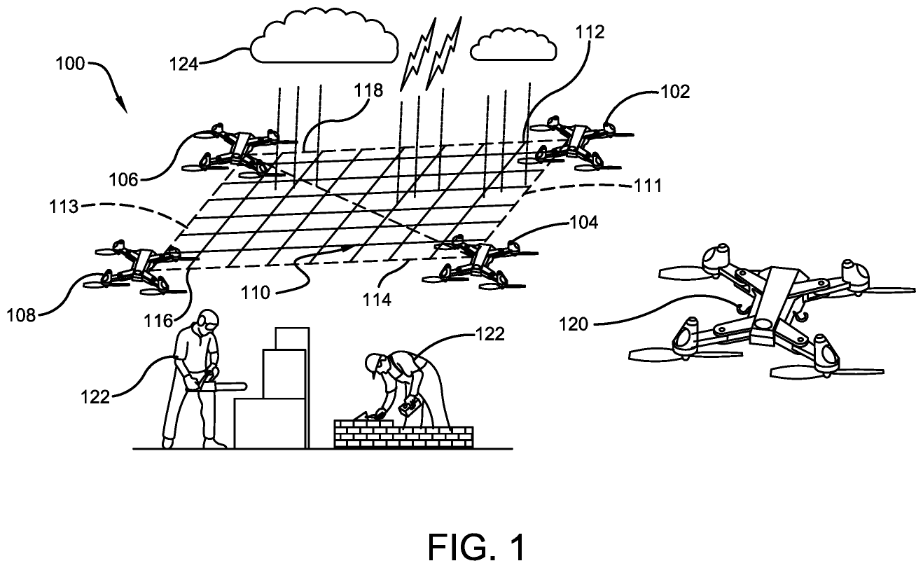

Referring initially to the drawings, FIG. 1 illustrates a perspective view of the portable and adaptable outdoor sunshade or shield protection system of the present invention in an installed position in accordance with the disclosed structure. The portable and adaptable outdoor sunshade or shield protection system 100 is designed as a unique solution for providing shade and shelter outdoors to users for protecting the users from sun or adverse weather conditions outdoors. More specifically, the system 100 includes at least three of the four drones shown as 102, 104, 106, 108 which are preferably quadcopters and are positioned in co-planar alignment in the deployed position as illustrated in FIG. 1. It is to be appreciated that three points define a plane. The drones 102-108 are programmable to be at different altitudes for protecting intended beneficiary individuals 122, such as at a construction site from weather elements 124. At least three of the drones (i.e., drones 102, 104, 106; or 104, 106, 108) are flown or hover in an arrangement that defines a plane therebetween. A protective tarp, shield, or sunshade 110, comprising exemplary shapes including triangular 111, 113, rectilinear, or rectangular (as shown in FIG. 1), is attached to each drone for providing a protective shield from weather elements. At least three (of the four) corners 112, 114, 116, 118 are firmly secured to a respective metal hook 120 each disposed on the drones 102-108, respectively.

The tarp, shield, or sunshade 110 remains substantially horizontal or planar and the drones 102-108 are positioned in a spaced apart arrangement to keep tension on the tarp, shield, or sunshade 110 with minimal slack. Also, the tarp, shield, or sunshade 110 can come in different sizes for providing protection over different surface areas or work projects and the drones 102-108 automatically maintain the space between them to keep the tension in the tarp, shield, or sunshade 110. The drones 102-108 are compact and lightweight and their size and weight may depend on the size of the tarp, shield, or sunshade 110.

In some embodiments of the present invention, the tarp, shield, or sunshade 110 is integrated to the drones 102-108 and when the drone system 100 is not used, the tension in the tarp, shield, or sunshade 110 is lost and the drones 102-108 are stored in a stacked position enclosed with the tarp, shield, or sunshade 110. In other embodiments, the tarp, shield, or sunshade 110 is removable from the metal hooks and can be removed and stored separately when the drone system 100 is not used for protection from weather elements. The drones 102-108 are specially designed having lightweight metal hooks 120 that do not cause drag or affect the flight efficiency of the drones.

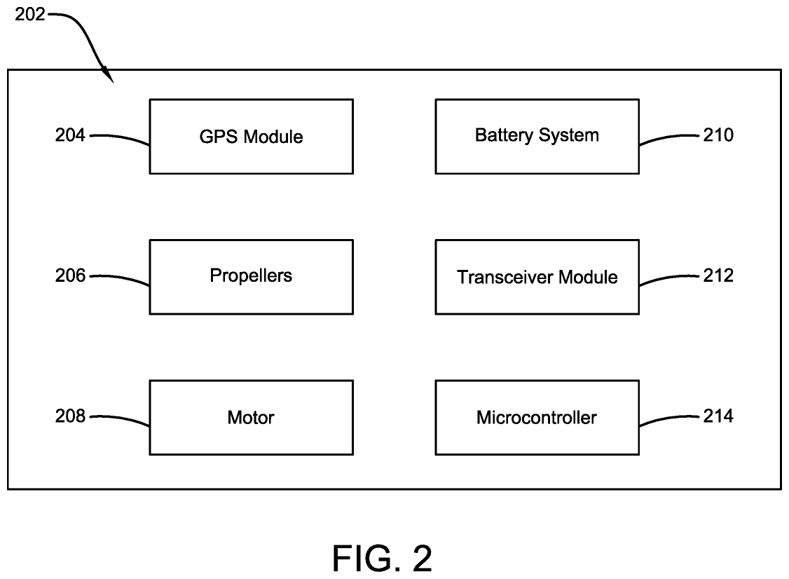

FIG. 2 illustrates a block diagram showing the functional components of a drone used in the portable and adaptable outdoor sunshade or shield protection system of the present invention in accordance with the disclosed structure. The drone 202 (which can be each of the drones 102-108) includes a GPS module 204 for determining and providing positioning of the drone 202. The GPS module 204 also helps in the drone positioning of at least the other two drones and thus helps in avoiding collision. The GPS module 204 works in conjunction with different sensors (not shown) such as accelerometer, gyroscope, and barometer for positioning and navigation of the drone 202.

For providing flight support and support to tarp's weight and tension, one or more propellers 206 are included in the drone 202. The propellers 206 provide the required mechanical power to the drone 202 to maintain flight altitude and flight time. The propellers 206 work in conjunction with the motors 208 which are preferably brushless motors.

For providing power to the motor 208 and the propellers 206, a battery system 210 is included in the drone 202. Preferably, Lithium-polymer (LiPo) batteries are used due to their high energy density and the battery system 210 is rechargeable and replaceable.

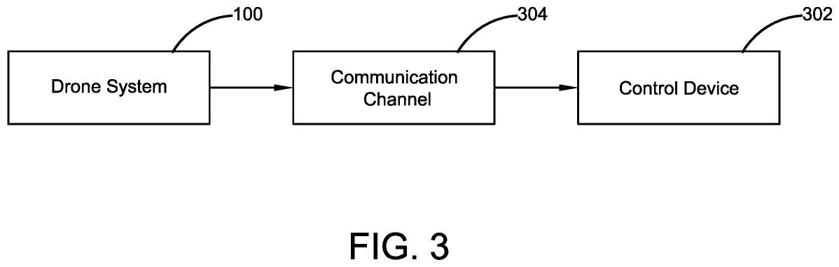

A transceiver module 212 is used for receiving and sending instructions from an operator or controller unit as illustrated in FIG. 3. The transceiver module 212 is configured to provide a radiofrequency or short-range communication channel for activating and deactivating the drone 202.

A programmable microcontroller 214 is included in the drone 202 to program different flight patterns and coordination between different drones. The microcontroller 214 is configured to receive signals from different modules, such as GPS module 204, and different sensors for providing a stabilized flight plan to allow the protective tarp, shield, or sunshade 110 to be placed horizontally.

Each drone used in the system 100 can be made of lightweight, durable materials like carbon fiber or lightweight plastics. Further, all the electronic components are embedded inside the drone for protection from weather elements. Further, it will be apparent to a person skilled in the art that the drone system 100 of the present invention can be designed for protecting different outdoor events, construction sites, agriculture, and other applications such as a driving user or a pedestrian. Also, the protective drone system 100 can be designed in compliance with aviation regulations, especially when used in populated areas.

FIG. 3 illustrates a block diagram illustrating activation of the protective drone system 100 of the present invention for installation in accordance with the disclosed architecture. The system 100 of the present invention can be activated using a control device 302 which can be in the form of a user device having an installed mobile application or can also be in the form of a local control box installed at a site. The control device 302 is in the wireless communication with the drone system 100 using a wireless communication channel 304. The communication channel 304 can be Wi-Fi, Bluetooth, satellite signal, or any other IoT based, telecom based, or any other wireless communication signal.

An instruction signal is sent from the control device 302 to the drone system 100 for activation of the system 100. In some embodiments, the microcontroller of each drone receives the instruction signal from the control device 302 and the drones are activated to achieve a preconfigured flight height for positioning the tarp in a planar orientation. In other embodiments, one of the drones, of the at least three drones, of the system 100 can be designated as the master drone for receiving the instruction signal from the control device 302 to activate the system 100. Thus, at least two other drones can be designated as the slave drones and autonomously maintain spacing from the master drone to ensure designated positioning for maintaining the tarp in a planar arrangement.

The drone system 100 can be manually activated as described above or can also be automatically activated at the preconfigured specific times or conditions. As an example, at least three of the drones 102-108 of the system 100 can automatically reach a preconfigured flight height and position when rain, sun, or any other inclement weather element is detected or anticipated.

The drone system 100 can be programmed with different flight height, flight time, and other parameters using the control device 302, and may also be solar powered. In some embodiments, the drones 102-108 can be pre-programmed using over the air (OTA) or satellite updates to meet requirements of different users. When at least three of the drones 102-108 hover at a height, the tarp, shield, or sunshade 110 supported by the at least three drones 102-108 protects or shields the surface underneath the tarp, shield, or sunshade 110 from weather elements. The drones supported sunshade or shield system 100 provides a flexible and adjustable solution that can adapt to different scenarios.

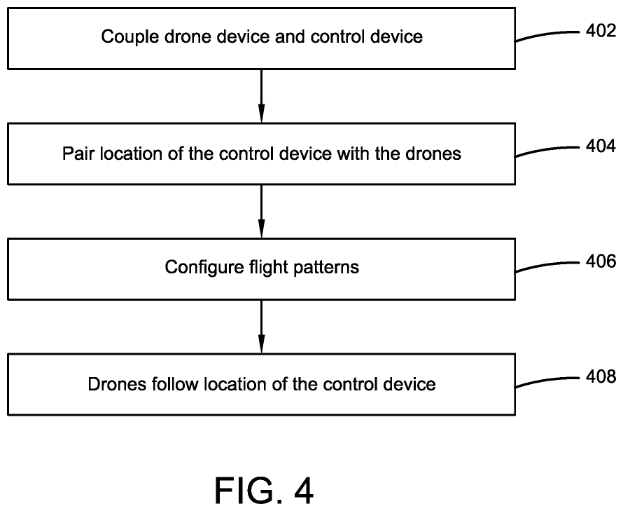

FIG. 4 illustrates a flow chart depicting the process of the drones-supported sunshade or shield system 100 of the present invention following the intended beneficiary of the tarp in accordance with the disclosed architecture. Initially, the drone system 100 is coupled to a control device which is preferably in the form of a mobile application installed user device (Step 402). The user device is carried by an intended beneficiary of the system 100 for protection from the weather elements. Then, location of the control device is paired with the microcontroller of all or the master drone of the system 100 (Step 404). The location paired is the real time location of the control device and then, in step 406, the drone system 100 is configured with a flight pattern in which the drones follow the real time location of the control device. Finally, when the system 100 is either automatically or manually activated, the drones and the associated tarp follows the location of the control device carried by the intended beneficiary and thus, protects the beneficiary or work project from weather elements above (Step 408).

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “drones-supported sunshade or shield system”, “portable and adaptable outdoor sunshade or shield protection system”, “protective drone system”, “drone system” and “system” are interchangeable and refer to the drones-supported outdoor sunshade or shield system 100 of the present invention.

Notwithstanding the foregoing, the drones-supported outdoor sunshade or shield system 100 of the present invention can be of any suitable size and configuration as is known in the art without affecting the overall concept of the invention, provided that it accomplishes the above-stated objectives. One of ordinary skill in the art will appreciate that the drones-supported outdoor sunshade or shield system 100 as shown in the FIGS. 1-4 are for illustrative purposes only, and that many other sizes and shapes of the drones-supported outdoor sunshade or shield system 100 are well within the scope of the present disclosure. Although the dimensions of the drones-supported outdoor sunshade or shield system 100 are important design parameters for user convenience, the drones-supported outdoor sunshade or shield system 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A mobile outdoor shield protection system comprising:
a mobile outdoor shield having at least three drones and a tarp connected therebetween;
wherein said at least three drones are mobile flying drones;
wherein said at least three drones positioned in space to define a plane;
wherein said at least three drones each connected to a respective corner of said tarp; and
further wherein said tarp is triangular in shape.

2. The mobile outdoor shield protection system of claim 1, wherein one of said at least three drones is a master drone and at least two of the said at least three drones are slave drones operating relative to said master drone.

3. The mobile outdoor shield protection system of claim 2, wherein said mobile outdoor shield having four drones connected to said tarp.

4. The mobile outdoor shield protection system of claim 3, wherein said four drones each having a hook for connecting to the respective said corner of said tarp.

5. The mobile outdoor shield protection system of claim 4, wherein said four drones are quadcopters positioned in a co-planar alignment.

6. The mobile outdoor shield protection system of claim 2, wherein said at least three drones are programmable to hover at different altitudes for orienting said mobile outdoor shield over an intended beneficiary.

7. The mobile outdoor shield protection system of claim 6, wherein said intended beneficiary is an individual.

8. The mobile outdoor shield protection system of claim 6, wherein said intended beneficiary is a work project.

9. The mobile outdoor shield protection system of claim 6, wherein said tarp is a sunshade.

10. A mobile outdoor shield protection system comprising:
a mobile outdoor shield having at least four drones and a tarp connected therebetween;
wherein said at least four drones are mobile flying drones;
wherein said at least four drones positioned in space to define a plane;
wherein said at least four drones each connected to a respective corner of said tarp; and
further wherein said tarp is rectilinear in shape.

11. The mobile outdoor shield protection system of claim 10, wherein one of said at least four drones is a master drone and at least three of the said at least four drones are slave drones operating relative to said master drone.

12. The mobile outdoor shield protection system of claim 11, wherein said at least four drones each having a hook for connecting to the respective said corner of said tarp.

13. The mobile outdoor shield protection system of claim 12, wherein said at least four drones are quadcopters positioned in a co-planar alignment.

14. The mobile outdoor shield protection system of claim 13, wherein said at least four drones are programmable to hover at different altitudes for orienting said mobile outdoor shield over an intended beneficiary.

15. The mobile outdoor shield protection system of claim 14, wherein said intended beneficiary is an individual.

16. The mobile outdoor shield protection system of claim 14, wherein said intended beneficiary is a work project.

17. The mobile outdoor shield protection system of claim 14, wherein said tarp is a sunshade.

18. A method of shielding a designated area with a mobile outdoor shield protection system, the method comprising the steps of:
providing a mobile outdoor shield having at least three drones and a tarp connected therebetween, wherein said at least three drones are mobile flying drones;
connecting a respective corner of said tarp to said at least three drones; and
positioning said at least three drones in space to define a plane.

19. The method of shielding a designated area of claim 18, wherein said tarp includes a shape selected from the group consisting of a triangle and a rectilinear shape.

20. The method of shielding a designated area of claim 19, wherein one of said at least three drones is a master drone and at least two of the said at least three drones are slave drones operating relative to said master drone.
